(19) United States
(12) Patent Application Publication
(10) Pub. No.: US 2013/0335328 A1
(43) Pub. Date: Dec. 19, 2013

(54) DIGITAL CHALKBOARD MENU

(71) Applicants: Mark Greenhalgh, Atlanta, GA (US); Andrew Hairetis, Sandy Springs, GA (US); Ryan Esparza, Atlanta, GA (US)

(72) Inventors: Mark Greenhalgh, Atlanta, GA (US); Andrew Hairetis, Sandy Springs, GA (US); Ryan Esparza, Atlanta, GA (US)

(73) Assignee: Six Continents Hotels, Inc., Atlanta, GA (US)

(21) Appl. No.: 13/495,573

(22) Filed: Jun. 13, 2012

(51) Int. Cl. G06F 3/02

(52) U.S. Cl. 345/168; 345/156

(57) ABSTRACT

A digital chalkboard menu may be configured and utilized to provide active and/or interactive information to customers and potential customers of a restaurant, café, or other food service area. The digital chalkboard menu may be configured to display a menu of food or related items that are available for sale at the merchant. The digital chalkboard menu may also be mounted in the food service area such that customers can view the items prior to and/or during purchase of menu items. In some aspects, the digital chalkboard menu may display a background and/or text in such a way that it resembles words handwritten in chalk on a chalkboard.

### BACKGROUND

Many hotels provide separate and distinct public spaces for customers and/or guests to utilize while traveling. For example, some hotels may have a lobby, a café, and/or a business center. Additionally, in some examples the café, or other food service area, may provide a menu of rotating food items for purchase. Active menus that are regularly changed, however, may often be difficult to update in a legible fashion. Thus, restaurant menus may be difficult to read, causing potential customers to eat elsewhere. As such, finding improved ways for hotels or food service areas, such as restaurants, to provide menus continues to be a priority.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a top view of one example hotel space. Here, multiple public spaces are separated by one or more partitions to create an open floor plan space for customers and/or guests of the hotel.

FIG. 2 illustrates an example café, restaurant, or food service area with a digital chalkboard menu for providing an updatable menu of food items for sale at the food service area.

FIG. 3 illustrates an example digital chalkboard menu configured to display items for sale at a café, restaurant, or food service area of a hotel.

FIG. 4 illustrates an example font that may be used by an example digital chalkboard menu to display menu items in a form that looks hand written with chalk.

FIG. 5 illustrates an example system architecture for implementing an example digital chalkboard menu.

FIG. 6 illustrates an example flow diagram for implementing an example digital chalkboard menu.

### DETAILED DESCRIPTION

### Overview

Embodiments of the present disclosure are directed to, among other things, providing a digital chalkboard menu for use within a merchant or other establishment such as, but not limited to, a hotel, a restaurant, a café, an Internet café, a coffee shop, a lounge, combinations of the foregoing, or the like. As an overview, a public space may be any interior or exterior space within a public or private facility including, but not limited to, a home, a business, a library, a park, etc., where people can gather and/or interact with one another. For example, a public space may include a lobby, a café, a restaurant, a lounge, a waiting area, or a business center (e.g., a computer terminal and/or printing station) within a private hotel. In some examples, the public spaces may be part of an open floor plan-style design, whereby half-walls, partitions, and/or other spaces (e.g., as opposed to full walls and/or doors) may be utilized to separate each individual area. That is, in some cases, the public spaces may be more fully integrated with one another to provide a single cohesive space to help customers and/or guests enjoy a variety of experiences without leaving the single space.

In some examples, a guest services module or front desk area may be utilized by a hotel to provide live help, guidance, and/or reservation services for checking in, checking out, and/or reserving rooms at one or more establishments. The guest services module may provide live support in the form of one or more hotel employees. Additionally, a café, restaurant, a bar, and/or food services area may be utilized by the hotel for presenting, providing, selling, and/or consuming food products. Food products may include pre-packaged items such as, but not limited to, cereal, crackers, gum, sandwiches, yogurt, milk, etc. Alternatively, or in addition, food products may also include food products that are made or otherwise prepared on-site such as, but not limited to, pasta, sandwiches, pizza, fries, meat and/or fish products, etc. Also, some food products may be made or otherwise prepared on-site and then packaged in such a way that they may appear pre-packaged even though they were made or prepared fresh at or near the food services area. For example, a sandwich may be prepared in a kitchen, adjacent, behind, or otherwise near the food services area, and then wrapped and sealed. In this way, the sandwich may appear to be pre-packaged although it was made on-site.

In some aspects, a digital chalkboard menu may be utilized to display menu items of the café, restaurant, and/or food service area. As used herein, café, restaurant, and food service area may apply to any portion of a building (e.g., a hotel) that may provide food items for sale. For example, a restaurant may include a one or more seating areas including, but not limited to, tables, booths, benches, or the like, where customers may be seated and served by a server or other staff member. In other examples, a café may include a counter or deli-style food service area where customers may view, select, and/or purchase food items. The café may also provide seating areas; however, the use of a server may not be provided. However, in some cases, a café and a restaurant may provide the same services. In other examples, a grab-and-go counter may be considered a food service area if and/or when food items are provided and/or available for purchase and/or consumption.

The digital chalkboard menu may, in some examples, be placed in and/or near food service areas. For example, the digital chalkboard menu may be wall-mounted behind a cash register or other point-of-sale (POS) device, on a wall near tables of a restaurant, and/or behind a deli counter, buffet line, or other food service area items, for view by customers. Alternatively, or in addition, the digital chalkboard menu may be mounted on a pedestal and placed at or near an entryway to a food service area (e.g., near a hostess station where customers wait to be seated). In other examples, the digital chalkboard menu may also be placed at each table (e.g., on the wall at each booth and/or integrated with a surface of the table) and/or carried to the tables like traditional menus.

In some examples, the digital chalkboard menu may be configured to display a menu of items that are available for sale at the café, restaurant, and/or food service area. Each item may be listed with or without a respective purchase price and may be indicated as regular menu items and/or special items. Additionally, the digital chalkboard menu may be configured to render a dark, chalkboard-style background that may be black, grey, green, blue, etc., to represent the chalkboard itself. While digital chalkboard menu text may be rendered with white, chalk-like font. In some examples, a standard font may be used to aid in legibility of the menu. Thus, a font that resembles handwritten chalk text may be utilized to give the impression that a person has handwritten the menu text on the digital chalkboard menu. In some examples, Microsoft® PowerPoint may be utilized to generate text that looks as if it were written with chalk.

A computing device including, but not limited to, a keyboard, a mouse, a monitor or display device, memory, and/or one or more processors, may be coupled (e.g., wirelessly or via a wired connection) to the digital chalkboard menu. In some examples, the computing device may be configured to receive input for selecting a font type and/or text input for displaying menu items. However, in other examples, the computing device may be configured to receive text from another computing device (e.g., a remote computer, a server, a database, a remote text input device, etc.). The computing device may be directly connected to the digital chalkboard menu and/or may be connected via a network connection such as, but not limited to, a local area network, a virtual private network, a wide area network, the Internet, and/or other private or public networks.

This brief introduction, including section titles and corresponding summaries, is provided for the reader's convenience and is not intended to limit the scope of the claims, nor the preceding sections. Furthermore, the techniques described above and below may be implemented in a number of ways and in a number of contexts. Several example implementations and contexts are provided with reference to the following figures, as described below in more detail. However, the following implementations and contexts are but a few of many.

### Illustrative Architecture

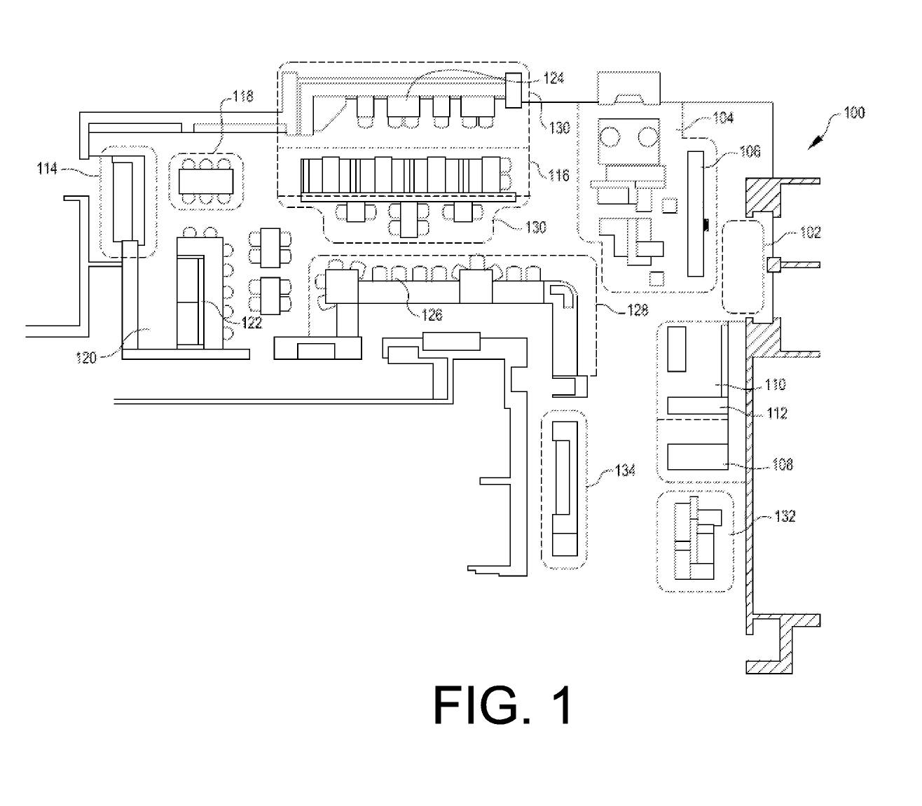

FIG. 1 depicts an illustrative top view of one example hotel space 100. Here, multiple public spaces may be separated by one or more partitions, areas, and/or other dividers to create an open floor plan space within the hotel. For example, an elevator lobby 102 may be separated from a media lounge 104 by a partition 106 (e.g., a free-standing wall). Similarly, a business center or business facility (e.g., an Internet café or an electronic-bar (E-bar)) 108 may be separated from a market (e.g., a storefront or other merchant facility) 110 by a partition 112. Alternatively, or in addition, in some examples, a first space may be separated from a second space by a third space, without a dedicated partition. For example, a chef station (e.g., a short-order cooking station) 114 may be separated from a booth seating area 116 (e.g., for eating food from the chef station 114) by a hot table 118 (e.g., a table dedicated to warm food products that may include one or more heating elements). As desired, other configurations are also possible.

In some aspects, the hotel space 100 may also include a video game area 120 dedicated to playing video games and/or a cold table 122 for providing food items. The video game area 120 and the cold table 122 may, in some examples, be separated by a waist-high partition such that guests using the cold table 122 may be able to see the video game area 120. Additionally, the cold table 122 may include a refrigeration component and/or an enclosure configured to hold ice near cold food items (e.g., milk, cream, yogurt, etc.). Additionally, in some example configurations, the hotel space 100 may include a banquet seating area 124, a bar 126, a “grab and go” or “to go,” cafeteria-style café 128 for selling food, snacks, drinks, etc., a high top seating area 130, and/or a lobby lounge 132. As noted above, each of these spaces, modules, stations, or areas may be integrated into an open floor plan via the use of partitions and/or other areas such as, but not limited to, partitions such as the interactive lobby partition 106 and/or the seating areas 116 and 130. However, in other examples, the absence of any partition may lend to the afore-mentioned open floor plan and/or integration.

In particular, the market 110 may be configured to sell one or more pre-packaged items such as, but not limited to, packaged soda, bottled water, chips, candy, gum, snacks, over-the-counter medications, or the like. Additionally, in some cases, the market 110 may be open 24 hours and/or may be unmanned, in that customers may be expected to take items to be purchased to the guest services counter 134 (e.g., the front desk) and/or the café counter 128, where live employees may be more regularly available. As such, the market 110 may be placed adjacent to or at least proximate to the front desk 134 and/or the café counter 128. Additionally, in some aspects, the bar 126 may be adjacent to and/or connected to the café 128. In this way, the space behind the counters of the bar 126 and the café 128 may be connected so that hotel employees, bartenders, and/or café staff can freely and easily maneuver between the bar 126 and the café 128. The bar 126/café 128 space may also be configured such that one is perpendicular to the other, forming an “L,” shaped counter. Further, in some aspects, the café 128 may be equipped with a digital chalkboard menu configured to display menu items and/or prices in a predefined, and/or consistent, font as if hand-written in chalk.

In some aspects, and as shown in FIG. 1, the market 110 may be directly across a hallway from the café 128. By way of example only, the E-bar 108 may be adjacent the market 110. More particularly, the E-bar 108 may also be partitioned from the market 110 by a free-standing wall. However, in some examples, a back wall of the market 110 may act as the partition. The E-bar 108 may include one or more computing devices, printers, display devices, and/or input devices. Additionally, the E-bar may include a flight status board for displaying flight information associated with one or more nearby airports. The flight status board may be a digital and/or flat-screen display device mounted to the wall of the E-bar 108. As such, customers and/or guests may utilize the E-bar 108 to check travel information such as flight status, rental car reservations, hotel reservations, or the like. Adjacent to the E-bar 108 may be a lobby lounge 132. The lobby lounge 132 may be configured with chairs, couches, etc., for customers and/or guests waiting on the guest services counter (i.e., the front desk) 134. In some configurations, the front desk 134 may be opposite the hallway from the lobby lounge 132 and/or the E-bar 108.

In some configurations, as noted above, the bar 126 may be perpendicular to the café counter 128. In this configuration, the open space adjacent to the bar 126 may be more suitable for eating/drinking/socializing than the lobby lounge 132 area. As such, several seating areas including, but not limited to, the high top seating area 130, the booth seating area 116, and/or the banquette seating area 124 may be adjacent to the bar 126 as well as the hot table 118, the cold table 122, and/or the chef station 114. Further, the chef station 114 may be regularly, or intermittently, staffed with one or more chefs for preparing individualized food orders (e.g., omelets, burgers, salads, etc.). Additionally, the hotel space 100 may be configured in such a way that nearly all areas, modules, and/or spaces are visible from one another, creating an open feeling to customers and guests. The ability to roam freely between areas and maintain perspective of each area may add to the overall integration of the hotel space 100.

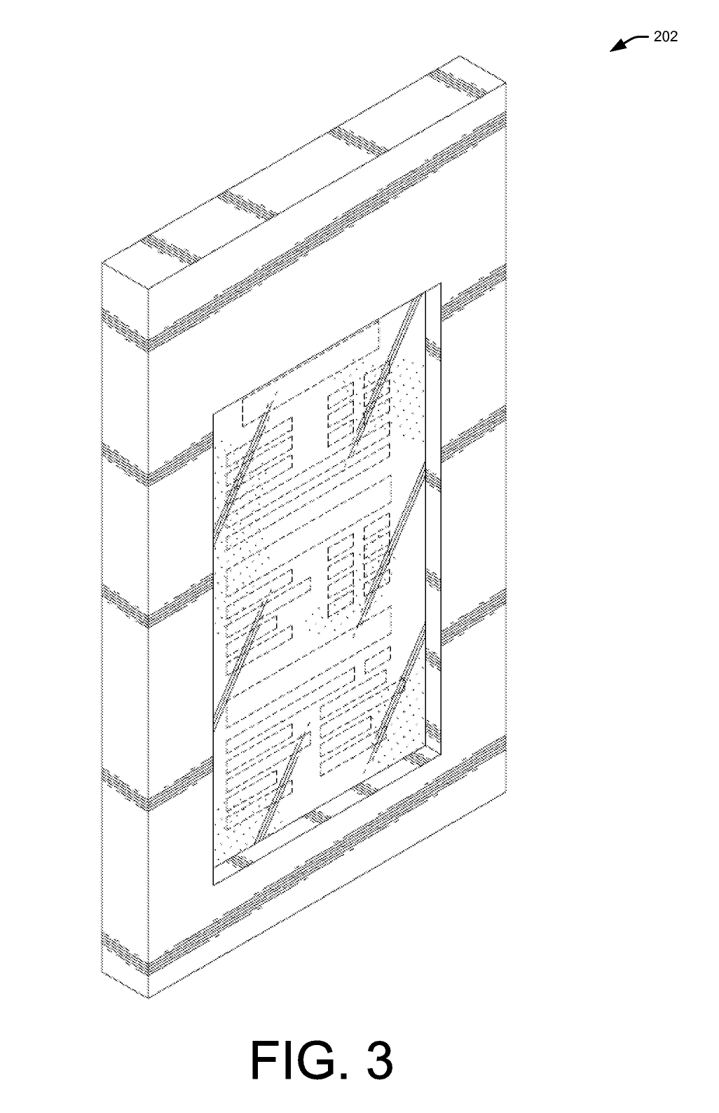

In some examples, as noted above, an elevator lobby 102 may be separated from a media lounge 104 by a partition 106. In this way, the media lounge 104 may be visible from, and an integrated portion of, the overall hotel space 100, while the elevator lobby 102 may only be visible from the market 110, café 128, front desk 134, and/or other areas that are not blocked by the partition 106. Regardless of the actual configuration, however, the partition 106 may be interactive and, thus, serve a dual purpose. On a first side, the side facing the media lounge 104 and shown in FIG. 3, the partition 106 may include a media cabinet for housing or otherwise supporting media components such as, but not limited to, a video display, a background for a projector display, a DVR, a DVD player, a CD player, an mp3 player, books, newspapers, magazines, etc. The media lounge 104 may also include couches, sofas, chairs, or the like for supporting the consumption of the media housed or otherwise supported by the interactive partition 106. Additionally, on a second side, the side facing the elevator lobby 102, the partition 106 may include a flight status monitor and/or interactive I/O components (e.g., a touch screen display device, a printer, etc.) for checking in, checking out, and/or confirming, making, printing, and/or canceling reservations. In this way, guests and/or customers may utilize functionality generally available via the E-bar 108 while on their way in and/or out of the hotel space 100 or the elevator lobby 102. The media lounge, in some examples, may also include a fireplace and/or a fireplace viewing area. The fireplace may be configured as a wood burning, a gas, a façade (e.g., a still picture of a fire), and/or a digital display fireplace.

As desired, other configurations for the hotel space 100 and/or the interactive lobby partition 106 may be possible. For example, the flight status monitor and/or other I/O components may be on either side of the partition 106 and/or on multiple sides of the partition (e.g., on the elevator lobby 102 side, the media lounge 104 side, a side that is adjacent to the elevator lobby 102 or the media lounge 104, but does not include either, or any combination thereof). Similarly, media cabinet components and/or shelving may also be located on any side of the partition 106. Additionally, while the hotel space 100 is shown in FIG. 1 having a bar counter 126 that is perpendicular to a café counter 128, these two counters may not actually be perpendicular. For example, they may be in a straight line, they may make a non-perpendicular angle, or they may not even be connected to each other. Further, one or more of the seating areas 116, 124, 130 may be omitted and/or one or more partitions may actually not be free standing (i.e., they may reach the ceiling of the room or area in which they reside) without departing from the spirit and meaning of the disclosure. As such, the hotel space 100 may include modules, systems, and/or other areas that are not shown in FIG. 1

### Illustrative Partitions

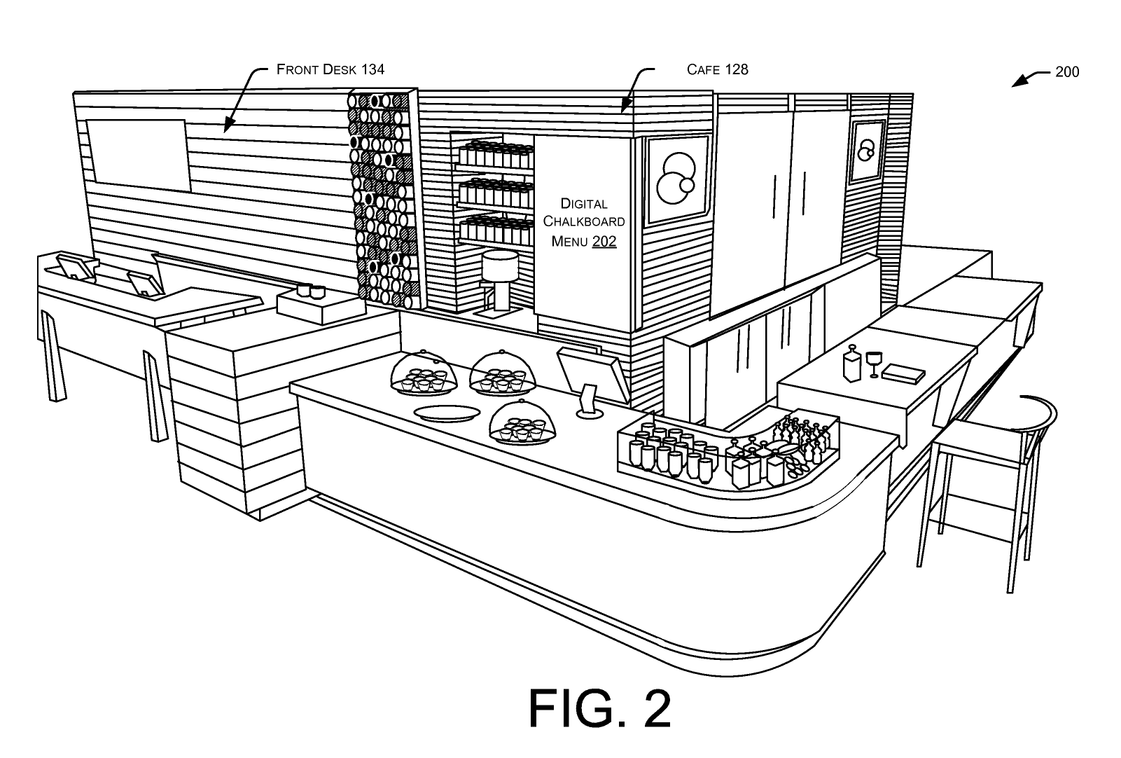

FIG. 2 depicts an illustrative public space 200 which may, in some examples be part of the hotel space 100 of FIG. 1; however, in other examples, may be part of any private or public space configured to provide food and/or food services. In one non-limiting example, the public space 200 may include a front desk (e.g., the front desk 134 of FIG. 1) and/or a café (e.g., the café 128 of FIG. 1). As shown here, in FIG. 2, the front desk 134 may include a counter and one or more computer monitors to aid in checking customers into and/or out of the hotel. The front desk 134 may, in some cases, be adjacent to or otherwise connected to the café 128. The café 128 may include one or more counters (e.g., the L-shaped counter may be part of the café and/or it may be part of a bar or deli counter) for displaying and/or consuming food items. The café 128 may also include a register (e.g., a cash register) or other POS device. Additionally, in some examples, the café 128 may include a digital chalkboard menu 202.

The digital chalkboard menu 202 may be wall-mounted behind, adjacent to, or at least near the POS device. Additionally, in some examples more than one digital chalkboard menu 202 may be provided behind, adjacent to, or at least near the POS device. In some configurations, the digital chalkboard menu 202 may be visible by customers as they view, request, and/or purchase food items. Further, in some examples, the digital chalkboard menu may be configured to display menu items in a consistent font that give the appearance of hand-written text on a chalkboard. This appearance may be effectuated by the use of one or more text-like fonts provided by or otherwise controlled by a computing device coupled to the digital chalkboard menu 202.

In some examples, the digital chalkboard menu 202 may be controlled by a computing device coupled to the digital chalkboard menu 202, yet not visible from the café 128. For example, the computing device may be located in the kitchen, behind the digital chalkboard menu 202, in another room, and/or under the counter. In at least one example, the POS device may be configured to receive payment from customers and to control the digital chalkboard menu 202. For example, the POS device may be coupled to the digital chalkboard menu 202 via cables that are not visible to the customers (such as those piped under the counter, under flooring, and/or behind (or through) the wall to which the digital chalkboard menu 202 is mounted. In some examples, the digital chalkboard menu 202 may be mounted flush to the wall of the café 128, mounted to the wall yet protruding, and/or adjustable (e.g., so that it may be angled up, down, and/or to the side). In some examples, this may enable users that are not directly in front of the POS device to view the menu. As noted briefly above, the digital chalkboard menu 202 may be configured to display one or more food or other restaurant/café items that may be for sale at the café, the bar, a restaurant, and/or other food service area of the public space 200.

FIG. 3 depicts an illustrative digital chalkboard menu 202, based at least in part on one example. In this example, the digital chalkboard menu 202 may include a border resembling a picture frame or a chalkboard frame. In some examples, a digital display screen or monitor may be recessed within the frame. However, in other examples, the screen or monitor may be flush with the frame. The dashed lines of the digital chalkboard menu 202 of FIG. 3 represent possible text that may be displayed by the digital chalkboard menu 202. For example, a heading may appear at the top to provide the name of the restaurant, café, bar, or other food service area at which the food items of the menu are being sold. Additionally, food items may be listed on a left column, with corresponding prices with and/or without tax on a right column of the digital chalkboard menu 202. Additionally, other headings and/or subheadings may be provided for indicating specials, special instructions, and/or additional information about the menu items and/or the café. Further, as noted above, the menu items may be updated regularly to include new food items and/or new pricing. Updates may occur periodically, automatically, based at least in part on a configuration, and/or manually at some interval or whenever the staff and/or manager decides to change the menu.

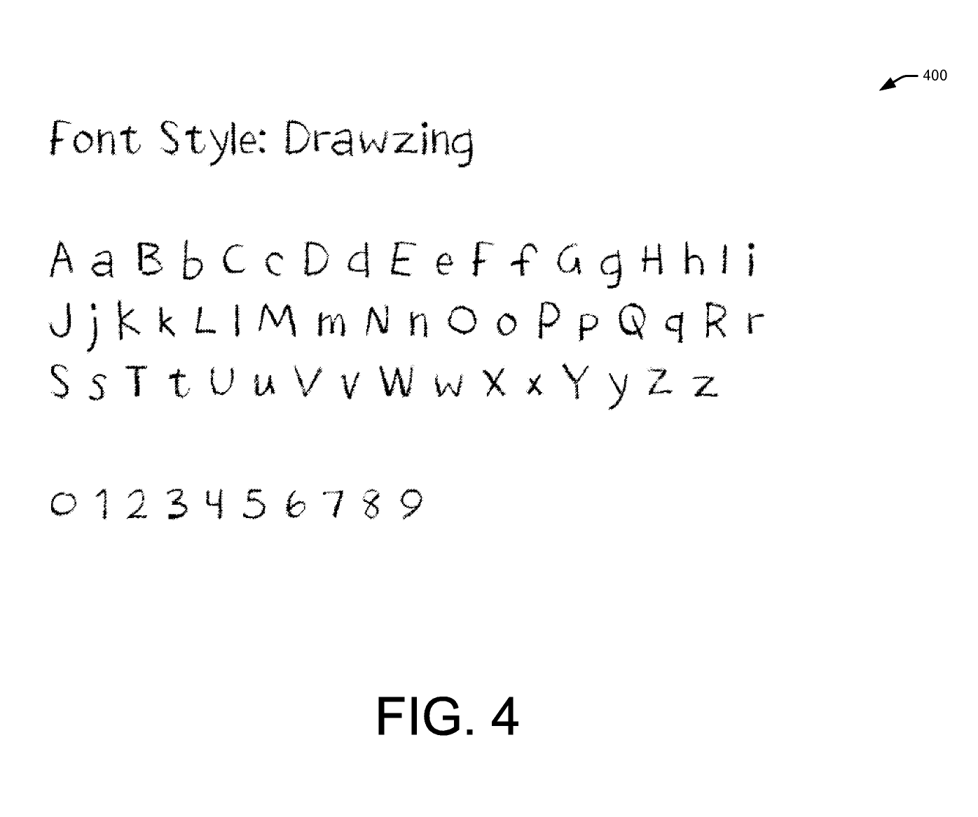

FIG. 4 depicts an illustrative font 400 that may be used to implement the digital chalkboard menu 202 described above. In some examples, this font may be called “Drawzing.” The “Drawzing” font may be configured and/or designed to resemble handwritten chalk letters and numbers. In some examples, when a font color of white is chosen and/or a dark background (e.g., black, grey, blue, and/or green) is selected, the font and/or the digital chalkboard menu 202 may appear as if it were handwritten in chalk on a chalkboard. However, in some examples, the use of a consistent font (e.g., the Drawzing font) may aid in legibility and make it possible for customers to effectively read the menu items, unlike with so many “real” chalkboards. As noted above, other fonts may be used as long as they provide a consistent look and feel, and at least somewhat resemble handwritten text.

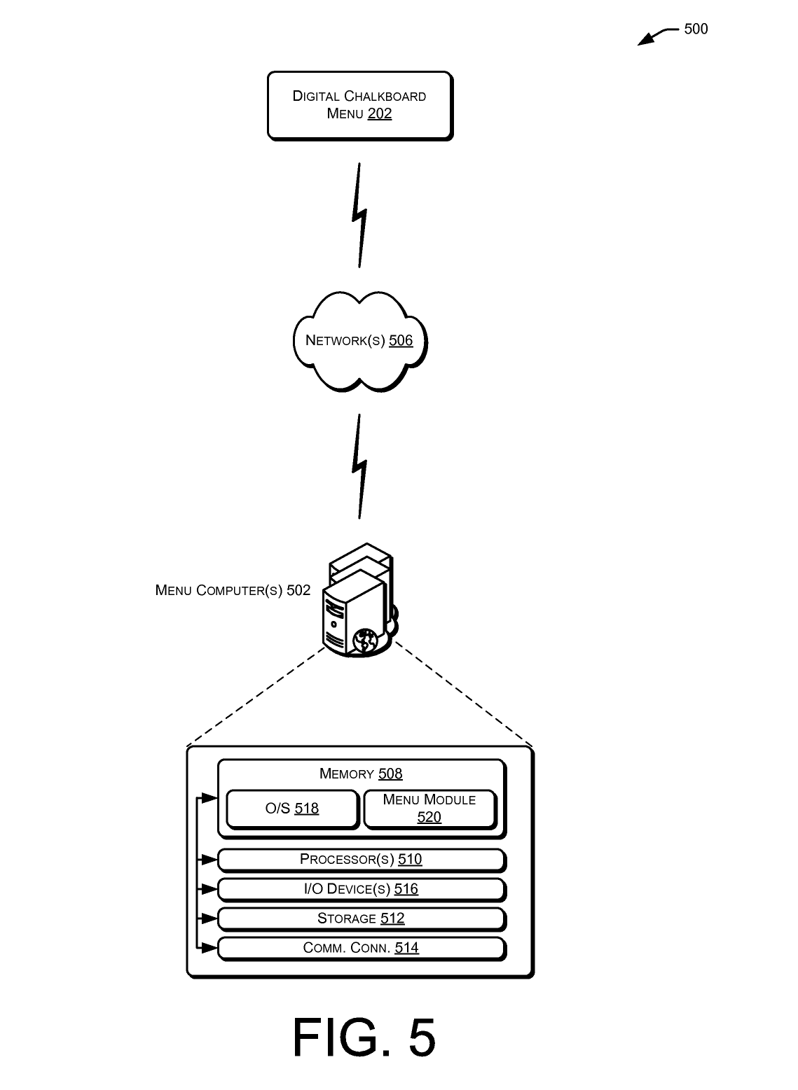

FIG. 5 depicts an illustrative system architecture 500 for implementing the digital chalkboard menu 202 in a café, restaurant, bar, or other food service area. In at least on example, the digital chalkboard menu 202 may be coupled to one or more menu computers 502 via one or more networks 506. The networks 506 may include any one or a combination of many different types of networks, such as cable networks, the Internet, wireless networks, cellular networks, and other private and/or public networks. The described techniques may also apply in instances where users interact with menu computers 502 via one or more user devices over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

In some aspects, the menu computers 502 and/or the digital chalkboard menu 202 may be any type of computing devices such as, but not limited to, mobile, desktop, thin-client, and/or cloud computing devices, such as servers. As noted above, in some examples, the menu computers 502 may be in communication with the digital chalkboard menu 202 via the networks 506, or via other network connections. The menu computers 502 may include one or more servers, perhaps arranged in a cluster, as a server farm, or as individual servers not associated with one another. These servers may be configured to store the content to be displayed on the digital chalkboard menu 202 and/or host a website (or combination of websites) viewable via the digital chalkboard menu.

In one non-limiting, illustrative configuration, the menu computers 502 may include at least one memory 508 and one or more processing units (or processor(s)) 510. The processor(s) 510 may be implemented as appropriate in hardware, computer-executable instructions, firmware, or combinations thereof. Computer-executable instruction or firmware implementations of the processor(s) 510 may include computer-executable or machine-executable instructions written in any suitable programming language to perform the various functions described.

The memory 508 may store program instructions that are loadable and executable on the processor(s) 510, as well as data generated during the execution of these programs. Depending on the configuration and type of menu computers 502, the memory 1508 may be volatile (such as random access memory (RAM)) and/or non-volatile (such as read-only memory (ROM), flash memory, etc.). The menu computers 502 or servers may also include additional storage 512, which may include removable storage and/or non-removable storage. The additional storage 512 may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 508 may include multiple different types of memory, such as static random access memory (SRAM), dynamic random access memory (DRAM), or ROM.

The memory 508, the additional storage 512, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 508 and the additional storage 512 are all examples of computer storage media.

The menu computers 502 may also contain communications connection(s) 514 that allow the menu computers 502 to communicate with a stored database, another computing device or server, user terminals, and/or other devices on the networks 506. The menu computers 502 may also include input/output (I/O) device(s) 516, such as a keyboard, a mouse, a pen, a voice input device, a touch input device (e.g., displayed on the digital chalkboard menu 202 itself), a display, speakers, a printer, etc. In some examples, the output device may be the digital chalkboard menu 202.

Turning to the contents of the memory 508 in more detail, the memory 508 may include an operating system 518 and one or more application programs or services for implementing the features disclosed herein including at least a menu module 520. The menu module 520 may be configured to receive, generate, host, transmit, or otherwise provide the data to the digital chalkboard menu 202. For example, a user of the system (i.e., hotel and/or restaurant staff) may input menu items (e.g., via a keyboard) and respective prices into the menu computers 502. As such, the menu module 520 may receive the input, process the input, store the input in the memory 508, and/or provide data associated with the input (e.g., a rendering based at least in part on the input) to the digital chalkboard menu 202. Additionally, in some aspects, the menu module 520 may receive input associated with a particular font, color, and/or format for which the digital chalkboard menu image is to be displayed. The menu module 520 may also be configured to provide font, color, and/or format image options to a user for selection. Further, the menu module 520 may be directly connected/coupled and/or fully integrated within the digital chalkboard menu 202 such that the networks 506 are not used and data may be transmitted directly to the display device (i.e., the digital chalkboard menu 202) as an output device 516 of the menu computers 502. That is, the menu computers 502 may be on-board the digital chalkboard menu 202 itself.

Additional types of computer storage media that may be present in the menu computers 502 and/or the digital chalkboard menu 202 may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the menu computers 502 and/or the digital chalkboard menu 202. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

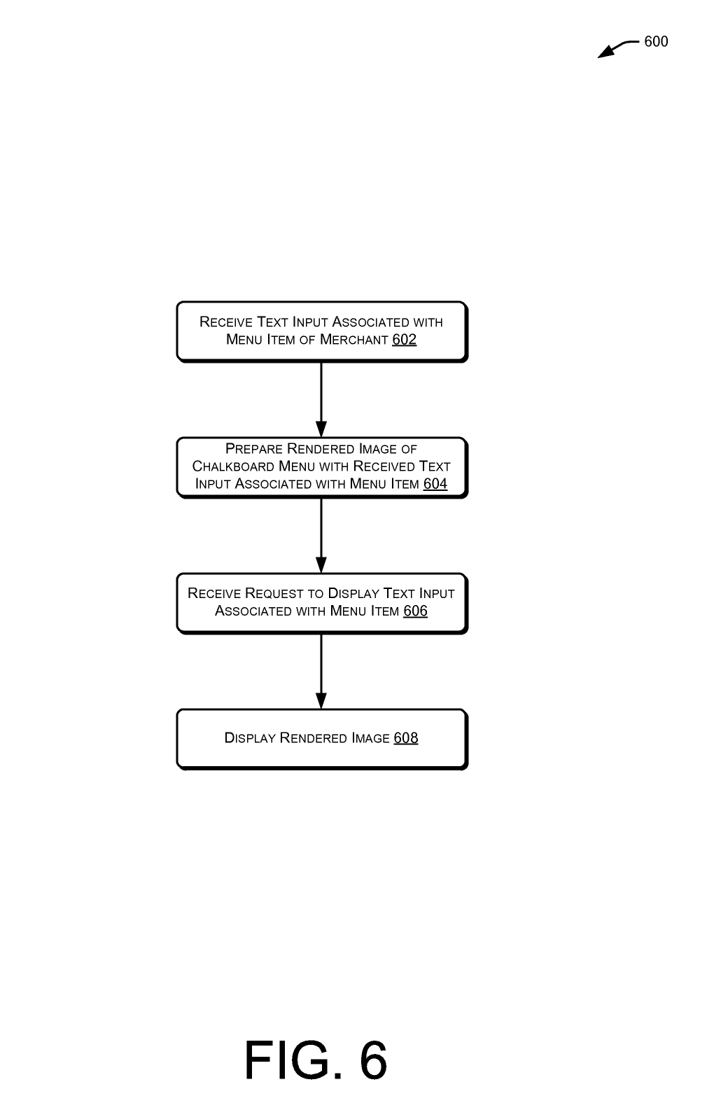

FIG. 6 illustrates an example flow diagram showing process 600 for providing a digital chalkboard menu. These processes are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

In some aspects, the process 600 of FIG. 6 may be performed by the one or more menu computers 502 and/or the digital menu chalkboard shown in at least FIGS. 2, 3, and 5. The process 600 may begin by receiving text input associated with a menu item of a merchant at 602. A merchant may include, but is not limited to, a hotel, a café, a restaurant, a bar, etc. that may sell or otherwise provide food items to customers. A menu item may include, but is not limited to, any food or other item for sale by the merchant. Additionally, in some aspects, the text to be displayed may be received from a remote computing device (e.g., a server, a database, a wireless text entry device, etc.). At 604, the process 600 may prepare a rendered image of the chalkboard menu with the received text input associated with the menu item. At 606, the process 600 may receive a request to display the text input associated with the menu item. That is, the user may have completed inputting the text for configuring the display of the digital chalkboard menu, and may now wish to have the image sent to the digital chalkboard menu for display. The process 600 may then end at 608 by displaying the rendered image. In some examples, display of the rendered image may occur after the request to display the text is received at 606. In other words, or in addition, the process 600 may wait to display the rendered image at 608 until after receiving the request to display the text at 606. However, in other examples, the process 600 may display the rendered image actively at 608 as text input is received at 602. That is, the text may be displayed at 608 substantially immediately after the input is received at 602, such that the user may view the text displayed on the digital chalkboard menu as they type the text on a keyboard.

The example architectures, floor plans, tools, digital chalkboard menu, methods, and computing devices shown in FIGS. 1-6 are provided by way of example only. Numerous other operating environments, systems, tools, floor plans, menus, methods, and configurations are possible. Accordingly, embodiments of the present disclosure should not be construed as being limited to any particular environments, systems, tools, floor plans, menus, methods, or configurations.

What is claimed is:

1. A digital chalkboard, comprising:
at least one memory for storing computer-executable instructions;
a display device configured to display a background image resembling a chalkboard surface and at least text associated with one or more menu items as if drawn with chalk on the chalkboard surface, the text comprising a predefined font;
an input device comprising one or more key inputs, separate from and coupled to the display device, configured to receive an input command and provide text associated with the input command to the display device for display; and
at least one processor configured to execute computer-executable instructions to:
receive the input command from the input device;
provide, to the display device, the background image resembling the chalkboard surface for display; and
provide, to the display device, an image of text resembling hand-written chalk text on the chalkboard surface for display, the image of text based at least in part on the received input command.

2. The digital chalkboard of claim 1, wherein the predefined font provides a consistent look and feel to the displayed text.

3. The digital chalkboard of claim 1, wherein the predefined font is configured to resemble at least one of hand-written chalk letters, hand-written words, hand-written numbers, or handwritten symbols.

4. The digital chalkboard of claim 1, wherein the background image comprises a predefined shade of grey and the text comprises a predefined shade of white.

5. The digital chalkboard of claim 1, wherein the display device is further configured to display an image associated with the one or more menu items.

6. The digital chalkboard of claim 1, wherein the one or more menu items are associated with food items for sale by a merchant.

7. The digital chalkboard of claim 1, wherein the input device comprises a keyboard.

8. The digital chalkboard of claim 1, wherein the input device is coupled to the display device or the at least one processor via a network connection.

9. The digital chalkboard of claim 8, wherein the network connection comprises a wireless network connection.

10. The digital chalkboard of claim 1, wherein the display device is fixedly coupled to a wall behind a counter of a merchant that provides the one or more menu items.

11. The digital chalkboard of claim 1, wherein the display device is mounted on a wall of a food service area.

12. The digital chalkboard of claim 11, wherein the food service area is located within a hotel.

13. A digital menu board, comprising:
a display device mounted to a wall of a merchant, the display device to display a chalkboard surface and at least text associated with one or more menu items of the merchant, the text to resemble hand-written chalk letters or numbers in a predefined font; and
an input device, coupled to the display device, configured to receive human input associated with the one or more menu items to be displayed on the display device.

14. The digital menu board of claim 13, wherein the display device is not a touch-screen device.

15. The digital menu board of claim 13, wherein the input device comprises a keyboard.

16. The digital menu board of claim 13, wherein the display device is mounted adjacent to a point-of-sale device of the merchant.

17. The digital menu board of claim 13, wherein the merchant comprises at least one of a hotel, a café, a restaurant, or a food service area.

18. A computer-implemented method for displaying menu items of a merchant, comprising:
preparing, for a display device of the computer, a rendered image of a chalkboard menu comprising a background resembling a chalkboard background and at least text associated with a menu item of a merchant, the rendered image of the text resembling text written by hand with chalk on the chalkboard background, the text comprising a predefined font; and
displaying, with the display device of the computer, the rendered image of the chalkboard menu to cause menu items of the merchant to be displayed as if hand-written with chalk.

19. The method of claim 18, further comprising receiving, from a text entry device, text input associated with the menu item of the merchant, and wherein the text associated with the menu item is based at least in part on the received text input.

20. The method of claim 18, further comprising receiving, from a remote computer, text associated with the menu item of the merchant, and wherein the text associated with the menu item is based at least in part on the received text.

21. The method of claim 18, further comprising receiving a request to display at least the text input associated with the menu item, the request being received prior to display of the rendered image.
